(19) United States
(12) Patent Application Publication
(10) Pub. No.: US 2003/0020348 A1
(43) Pub. Date: Jan. 30, 2003

(54) Magnetic repulsion engine

(76) Inventor: Joesph Vito Pellegrino, Bayport, NY (US)

Correspondence Address: Joesph Vito Pellegrino, 254 Terrace Rd, Bayport, NY, 11705, US

(21) Appl. No.: 09/911,652

(22) Filed: Jul. 24, 2001

(51) Int. Cl. H02K 21/12

(52) U.S. Cl. 310/156.01

(57) ABSTRACT

This invention is an engine that uses the power of the repelling force of natural magnets to create a turning energy. This turning energy is produced by a system of conveyer belts, pulley rings, and gears that are connected to a “magnetic hammer” piece to react at the right time to allow the “magnetic hammer” piece to go up and repel the magnet on an arm and the other hammer piece proceeding the arm to go down and out of the way for the arm to pass. This arm will be connected to a middle bar that will be connected to the system just stated and be the object that turns to which can be used for anything that needs a turning energy. This invention will be an alternative to engines that run on other more expensive or time costly power sources.

### CROSS-REFERENCE TO RELATED APPLICATIONS

Non-applicable

### STATEMENT REGARDING FEDERALLY SPONSORED RESEARCH OR DEVELOPMENT

Non-applicable

### REFERENCE TO A MICROFICHE APPENDIX

Non-applicable

### BACKGROUND OF THE INVENTION

Non-applicable

### BRIEF SUMMARY OF THE INVENTION

This invention is an engine running solely on the power of natural magnets. The magnets repel each other in the engine causing a turning motion of a middle bar causing a system of gears, pulleys, and conveyer belts to move to allow posistioning of a “magnetic hammer” piece to come up and allow the magnet connected to the piece to repel a magnet on an arm connected to the middle bar.

In the past engines have relied on different power sources like gasoline, coal, manual windup, etc which usually need to be replaced in a short time and are also costly and or take too much physical involvement. This engine on the other hand will have a power source that needs to be changed every estimated 10 to 20 years (different type of magnets may vary though) and the power source is cheaper.

### BRIEF DESCRIPTION OF THE SEVERAL VIEWS OF THE DRAWING

Non-applicable

### DETAILED DESCRIPTION OF THE INVENTION

The parts of this invention are described as if free floating in air but you have to imagine them being connected to a casing. To begin with the arms connected to the middle bar as discussed in the brief summary of the invention which will need to be in a vacuum chamber in the casing and the chamber walls if in close proximity of the magnet's field must be of a non-magnetic material. The arms will be of an L or simliar shape or can be linear in shape depending on the posistion you want the “magnetic hammer” piece. The part of the arm that will be in the magnet's field will need to be made of non-magnetic material to prevent the magnetization of the rest of the engine's parts. The middle bar where the arm or arms will be connected to will also have 2 gears connected to it. A ratchet gear with a pawl with friction resistant material or substance on it's side and or on the gear teeth themselves and a spring attached to the pawl to prevent gravity to be the only force pushing the pawl into the gear's teeth and this will allow the middle bar to turn in one direction and not in another making sure the arms on the middle bar go only in the direction of the propellment from the repellsion of the 2 magnets. The second gear will be a spur gear that will be connected to a spur gear that will be in the center of the side and part of the first pulley ring in a conveyer belt.

The conveyer belt will have holes for teeth that will be inside and in the middle of the ring part of the pulley rings. The conveyer belt will start with the spoken pulley ring with a spur gear in the center of it's side and continue with pulley rings posistioned in such a way that they will decress the work load of the pulling down of the “magnetic hammer” piece and will be placed on the side of the conveyer belt that will be doing the pulling action. The conveyer belt's last pulley ring will have a worm gear as part of it coming out of one side in the center and will be connected to a double sided spur gear. The double sided gear will have one side with the normal number of teeth that will be extended out enough to be connected to the worm gear and the other side will have gear teeth to allow the “magnetic hammer” piece to go down and be pushed down and will be connected to the teeth that will be on the side of the hammer piece and go back up when a gap that will be in between the teeth disconnects the gear from the hammer piece. The double sided gear can be made with the side connecting to the worm gear to be smaller then the other side to create a gear train effect for desired RPM output.

The “magnetic hammer” piece will have several parts to it. One external piece to which part of it that will be in the magnet's field will be made of non-magnetic material and will have the gear teeth spoken about on one of its side's and have a cavity inside of it with an opening on it's bottom. Inside the cavity the bottom of the top side will have a part extending out of it that will have shock absorbing material attached to the end of it. This part will go through a hole on the top of the internal piece with the shock absorbing material end being inside the internal piece. The internal piece will be smaller in size to the external piece and have a cavity inside it where the part with the shock absorbing material will be going into. Both on the internal piece's outer sides and external piece's inner sides will consist of either pieces and grooves on them, where the piece will go into the groove and the groove will be of a certain measurement being closed off at the top and bottom to allow the hammer piece to go up the needed distance and back down again at a needed distance. There will be a spring that will be surrouding the part with the shock absorbing material and will be connected to the bottom of the top part of the external piece and the top of of the internal piece. This will allow the piece the energy needed to go in the direction away from the internal piece and into posisition to repel the arm with magnet on it away from the magnet that will be attached to the top side of the external piece. There will be surrounding at the bottom and outside the internal piece a lip, extending in a direction away from it allowing more stabilty to the hammer piece.

The “magnetic hammer” piece can be changed to have the spoken lip of the internal piece to instead be surrounding the bottom of the external piece and have straight openings closing off at the top and bottom of the external piece to allow double sided hooks or simliar shaped with shock absorbing material, that are connected from the internal piece, connected on top of each to go into and allowing the internal piece to go past the external piece with an opening on the top of the external piece and the sides where the internal piece and external piece touch being lubricated with friction resistant substance or material and placing the gear teeth on the side of the internal piece and extending the gear teeth out, so that grooves of the gear teeth of the double sided gear can connect to it, with an opening on with no closing at the top of the external piece to allow the gear teeth up and out of the opening while having the magnet being connected to the top of the internal piece via any way, material, and or device and a spring attached inside a cavity to both the bottom of the top piece of the internal piece and the casing of this engine now also having at least the part of the internal and external piece that will be in the magnet's field to be made of non-magnetic.

Double sided gears can be added in between the spur gear on the middle bar and the pulley ring with the spur gear on it's side to create a gear train as well as making the double sided gear side that is connected to the worm gear can be smaller in size to the second side for extra needed RPM output. There will be 2 “magnetic hammer” pieces for every one arm with the magnet on it to allow the “magnetic hammer” piece to react at the right time where as the first “magnetic hammer” piece to go up and stay up when the arm has passed it and the next “magnetic hammer” piece proceeding the arm to go down allowing the arm to go pass it via from the propellment of the repullsion of the magnets on the first hammer piece and the arm's magnet. The amount of arms will be dependent on how much power is wanted from the engine. The magnets have a certain distance that they will be propelled from the repellment of each other. There are elements in this apparatus that will be taking a certain amount away from that distance to which the following will effect that distance: friction, work output left over from the pulleys, and anything that this device will be used to spin. All surfaces rubbing against each other in this engine should be lubricated for decressing friction. The magnets that would be prefered to be used on this engine would be something on the more powerful side of the spectrum like rare earth magnets. This engine will produce a spinning energy with the middle bar to be used with for example to have a magnet connected with a bar to the middle bar to spin around in an electric generator.

I claim:

1. A magnetic repulsion engine, comprising:
a) arm(s) in the shape of a L or simliar shape, with a natural magnet connected via any way, material, and or device to the end of the smaller part of the L or simliar;
b) a ratchet gear with a spring attached to pawl;
c) a middle bar;
d) pulley rings with teeth inside the ring part's center;
e) pulley rings with said teeth and with spur gear on it's side;
f) pulley rings with said teeth and with a worm gear in the center of it's side;
g) conveyer belts which will have holes for teeth pieces;
h) double sided spur gears with one side consisting of the normal number of teeth and the other which will have a gap of missing teeth between teeth;
i) “magnetic hammer” pieces that will consist of 4 parts: 1 external, 1 internal, 1 spring, and 1 natural magnet;
j) natural magnets.

2. The apparatus of claim 1, wherein said L or simliar shaped arm(s) with said magnets will be propelled around a nessecary vacuum chamber, which will be part of the casing this engine will go in, which will be connected to a middle bar, all at one level, and will be pointing the shorter part of the L or simliar shape toward the level of said spur gear on said middle bar.

3. The apparatus of claim 1, wherein said middle bar will either be one with or be connected to via any way, part, material, and or device with said arm(s), said spur gear, and said ratchet, gear.

4. The apparatus of claim 1, wherein said ratchet gear is connected to a pawl with friction resistant material or substance on the side or on the gear teeth themselves contacting the gear teeth and with spring attached via any way, material, and or device to the pawl and to a part of the casing, to be a force other then gravity to drive the pawl back into the teeth of said gear to prevent the arm(s) with magnets from going backwards.

5. The apparatus of claim 1, wherein said spur gear that is on the middle bar will be connected to said spur gear part of said pulley ring with spur gear on the center it's side on said conveyer belt.

6. The device of claim 1, wherein said conveyer belt consisting of holes for teeth which will be connected to teeth in the center of the rings in said pulley rings.

7. The device of claim 6, wherein all other said pulley rings between said pulley ring with spur gear on it's side and said pulley ring with worm gear on it's side, will be posistioned in such a way that they will decress the work load of the pulling down of said “magnetic hammer” piece and will be placed on the side of said conveyer belt that will be doing the pulling action.

8. The device of claim 6, wherein said pulley ring with worm gear from said conveyer belt will be connected to the one side without missing teeth of said double sided spur gear.

9 The apparatus of claim 1, wherein said double sided spur gear with the normal amount of gear teeth which will extend out enough to be connected to said worm gear and a second side with a gap of missing gear teeth between gear teeth will connect to said “magnetic hammer” piece to allow the “magnetic hammer” piece opposing motion from the internal piece other then inward pulling action it will normally be doing with the teeth on the piece's side.

10. The apparatus of claim 1, wherein the “magnetic hammer” piece, comprising:
a) said external having a cavity and having a part inside said piece's cavity at the bottom of the top part with shock absorbing material connected to the end of it and also having gear teeth that will be on one of said piece's external side;
b) said natural magnet connected on top of said external piece via any way, material, and or device;
c) said internal piece which will have a cavity inside it and a hole on the top of it;
d) a spring connected via any way, material, and or device to the bottom of the top part of said external piece and the top of said internal piece and surrounding the part with shock absorbing material at the end of it of said external piece.

11. The device of claim 10, wherein at least the part of said external piece that will be in the magnet's field will be made of non-magnetic material.

12. The device of claim 10, wherein said internal piece will go inside said external piece's bottom with an opening to it's cavity.

13. The device of claim 10, wherein said internal piece which will be smaller in size of said external piece.

14. The device of claim 10, wherein pieces that will fit into groves wherein each will be built into either of said external piece inner sides of said cavity and on the outer sides of the internal piece with the grooves being closed off at the top and bottom and being of a necessary length and will have a friction resistant substance or material one or both of them.

15. The device of claim 10, wherein the part of said external piece with shock absorbing material on it to be fixtured through the internal piece's top side's hole and inside said piece's cavity.

16 The device of claim 10, wherein said hole's size on top of the internal piece will not allow said external piece's part with shock absorbing material on it to go through it.

17. The device of claim 10, wherein said spring is connected via any way, material, and or device to the bottom of the top part of said external piece and the top of said internal piece and surrounding the part with shock absorbing material at the end of it of said external piece causing a propellment away from the internal piece of said external piece.

18. The device of claim 10, wherein said external piece's bottom of it's top will be elongated in the direction of the internal piece to make distance between the spring and the field of the magnet on top for allowing the spring to be made of magnetic attracting material without being affected by the magnet's field.

19. The device of claim 10, wherein said internal piece's bottom has a lip surrounding the outside of the piece and extending in a direction away from it allowing more stabilty.

20. The device of claim 10, wherein said part of the external piece with shock absorbing material on it will have a friction resistant material or substance.

21. The device of claim 10, wherein said external piece can be changed to have said lip of claim 19 surrounding the bottom of it and have straight openings closing off at the top and bottom of said external piece to allow double sided hook or simliar shaped with shock absorbing material, that are connected from the internal piece, connected on top of each to go into and allowing the internal piece to go past the external piece with an opening on the top of the external piece and the sides where the internal piece and external piece touch being lubricated with friction resistant substance or material and placing the gear teeth on the side of the internal piece and extending the gear teeth out, so that grooves of the gear teeth of the double sided gear can connect to it, with an opening on with no closing at the top of said external piece to allow the gear teeth up and out of the opening while having said magnet being connected to the top of the internal piece via any way, material, and or device and a spring attached inside a cavity to both the bottom of the top piece of the said internal piece and the casing of this engine and now also having at least the part of the internal and external piece that will be in the magnet's field to be made of non-magnetic.

22. The device of claim 10, wherein the number of teeth on the side of the “magnetic hammer” piece to allow the piece to be pushed out of the magnetic field of said magnet on said arm passing over it.

23. The apparatus of claim 1, wherein double sided spur gears can be added in between said spur gear on middle bar and said pulley ring with spur gear on ifs side to form a gear train and said double sided gear side that is connected to the worm gear can be smaller in size to the second side if needed for RPM output.

24. The apparatus of claim 1, wherein the “magnetic hammer” piece can be reposistioned at a right angle to the arm and connected to a different part of the casing allowing the arm(s) with magnets at the end of them to be in a linear shape instead of an L shape.

25. The apparatus of claim 1, wherein there will be two systems of said conveyer belts, pulley rings, gears, and “magnetic hammer” pieces for every one said arm with magnet on it to allow the “magnetic hammer” piece to react at the right time to allow the first said “magnetic hammer” piece to go up and stay up when the arm has passed it and the next “magnetic hammer” piece proceeding the arm to go down allowing the arm to be pushed by the repulsion of the magnet passed it.

26. The apparatus of claim 1, wherein the walls of the vacuum chamber must be made of a non-magnetic material if the walls are in proximity of the magnet's field.

27. The apparatus of claim 1, wherein at least part of said arm(s) with magnet on it or them that will be in the field of the magnet must be made of non-magnetic material.

28. The engine of claim 1, wherein said natural magnets on both said arm(s) and said “magnetic hammer” pieces and will be posistioned with opposing poles facing each other causing a repellant of the said magnets to cause a propellment of said arm(s) in a circular spining motion, causing the middle bar to turn inturn causing the spur gear to turn and systems of converyer belts, pulley rings, gears, and “magnetic hammer” pieces to react to said spur gear and cause said “magnetic hammer” pieces to pop up and down when needed to accomplish said propellment, causing anything else connected to the middle bar to turn producing a turning energy.
